(19) United States
(12) Patent Application Publication
(10) Pub. No.: US 2012/0085526 A1
(43) Pub. Date: Apr. 12, 2012

(54) HEAT SINK

(76) Inventor: Fu-Lin YEH, New Taipei City (TW)

(21) Appl. No.: 13/252,395

(22) Filed: Oct. 4, 2011

(30) Foreign Application Priority Data
Oct. 11, 2010 (TW) 099219546

(51) Int. Cl. F28F 7/00; B82Y 99/00

(52) U.S. Cl. 165/185; 977/742; 977/734

(57) ABSTRACT

A heat sink has a stand and a nano-carbon film. The stand is made of a strong and thermally conductive material and includes a lower surface, two sides and two sidewalls. The sidewalls are respectively formed on the sides of the stand. The nano-carbon film can provide excellent heat dissipation effect, is formed on the lower surface of the stand and includes at least one hole. The heat sink is mounted in an electronic device to make the stand contact electronic components through the hole of the nano-carbon film. Therefore, the heat generated by the electronic components can be dissipated by both the stand and the nano-carbon film. Besides, the heat sink is small in size so that it can be applied to small electronic devices. Moreover, the stand can hold the input unit and structurally reinforce the housing of the electronic device.

### BACKGROUND OF THE INVENTION

1. Field of the Invention

The present invention relates to a heat sink, and more particularly to a heat sink being small in size to achieve miniaturization.

2. Description of the Prior Arts

A heat sink is mounted in an electronic device to dissipate the heat generated by electronic components such as CPUs, south bridge chips, north bridge chips and graphics cards, and to keep the components within safe operating temperature limits.

With reference to FIG. 5, a conventional electronic device comprises a housing 300, at least one input unit 40, at least one electronic component 50 and a heat sink 30. The housing 300 is made of plastic and may include at least one metal panel 301. The at least one metal panel 301 is attached to the housing 300 to reinforce the housing 300 and prevent deformation. The at least one input unit 40 is mounted on and outside the housing 300 for users to operate. The at least one electronic component 50 is mounted inside the housing 300. The heat sink 30 is mounted inside the housing 300, contacts the electronic component 50 and includes a base 31 and multiple fins 32 straightly extending from the base 31. The base 31 absorbs the heat from the electronic component 50 and transmits the heat to the fins 32, then the fins 32 radiate the heat into the air.

The finned heat sink 30 is the most widely used type of heat sink at present. The larger surface area of fins 32 is provided, the more heat will be dissipated. However, the finned heat sink 30 is relatively bulky so that it cannot be applied to small electronic devices. Besides, the housing 300 made of plastic is not strong enough so that the metal panel 301 must be attached thereto and thus results in a high manufacturing cost.

To overcome the shortcomings, the present invention provides a heat sink to mitigate or obviate the aforementioned problems.

### SUMMARY OF THE INVENTION

The main object of the present invention is to provide a heat sink being small in size to achieve miniaturization.

To achieve the foregoing objective, the heat sink in accordance with the present invention comprises a stand and a nano-carbon film. The stand is made of a strong and thermally conductive material and includes a lower surface, two sides and two sidewalls. The sidewalls are respectively formed on the sides of the stand. The nano-carbon film can provide excellent heat dissipation effect, is formed on the lower surface of the stand and includes at least one hole. The heat sink is mounted in an electronic device to make the stand contact electronic components through the hole of the nano-carbon film. Therefore, the heat generated by the electronic components can be dissipated by both the stand and the nano-carbon film. Besides, the heat sink is small in size so that it can be applied to small electronic devices. Moreover, the stand can hold the input unit and structurally reinforce the housing of the electronic device.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a first embodiment of a heat sink in accordance with the present invention;

FIG. 2 is a side view in partial section of an electronic device with the heat sink in FIG. 1;

FIG. 3 is a side view in partial section of another electronic device with a second embodiment of a heat sink in accordance with the present invention;

FIG. 4 is a side view of a third embodiment of a heat sink in accordance with the present invention; and

FIG. 5 is a side view in partial section of a conventional electronic device in accordance with the prior art.

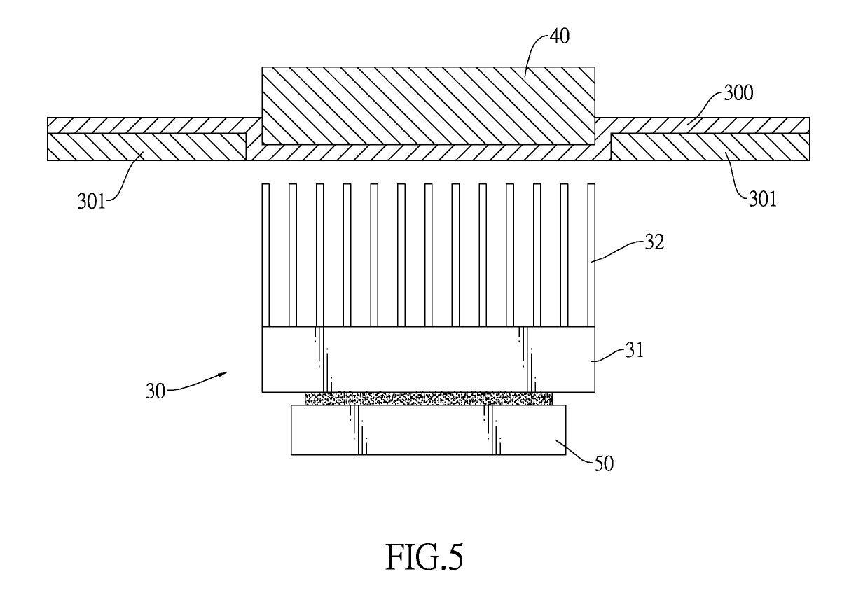

### DETAILED DESCRIPTION OF THE PREFERRED EMBODIMENTS

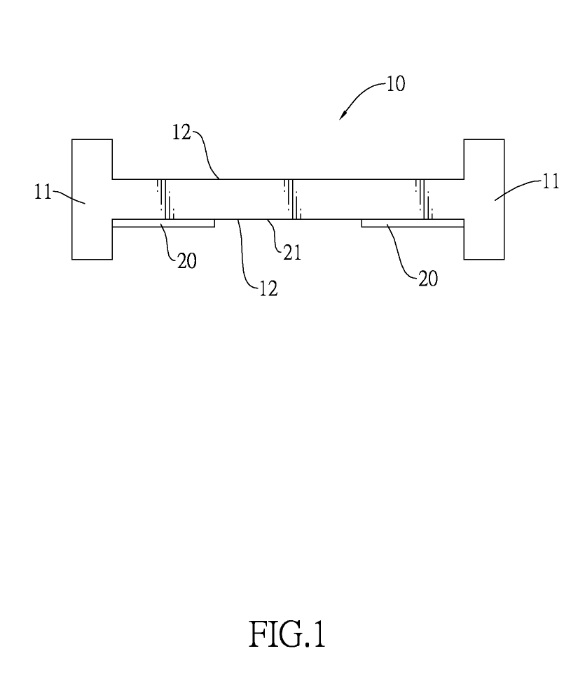

With reference to FIG. 1, a heat sink in accordance with the present invention comprises a stand 10 and a nano-carbon film 20.

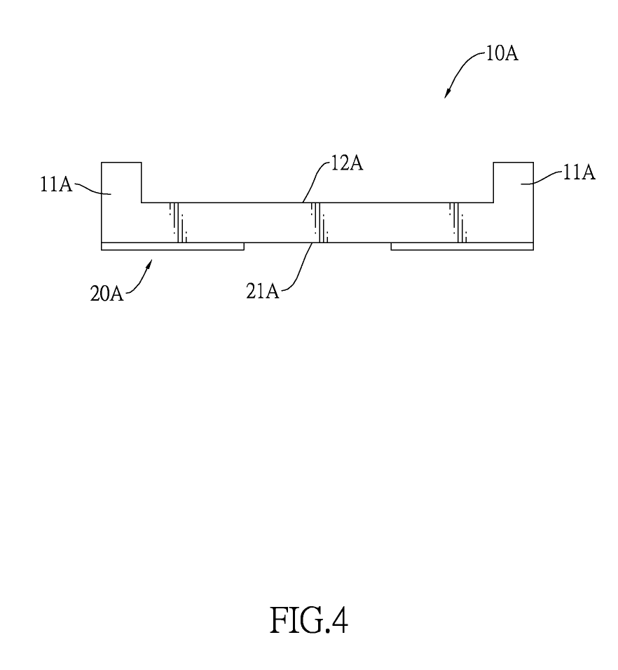

The stand 10 is made of metal, carbon fibers or other strong and thermally conductive materials. Preferably, the stand 10 is made of magnesium-lithium alloy, which is light in weight, strong and highly thermally conductive. The stand 10 is H-shaped and includes an upper surface, a lower surface, two sides and two sidewalls 11. The sidewalls 11 are respectively formed on the sides of the stand 10 and extend upward and downward so as to form two chambers 12 between the sidewalls 11 and to form an H-shaped configuration. With reference to FIG. 4, in another embodiment, the stand 10 is U-shaped. The sidewalls 11A are respectively formed on the sides of the stand 10A and extend upward so as to form a chamber 12A between the sidewalls 11A and to form an U-shaped configuration.

With reference to FIG. 1, the nano-carbon film 20 is made of carbon nanotubes or graphene that provides excellent heat dissipation effect and is formed on the lower surface of the stand 10 by Chemical Vapor Deposition (CVD) or other suitable means and includes at least one hole 21.

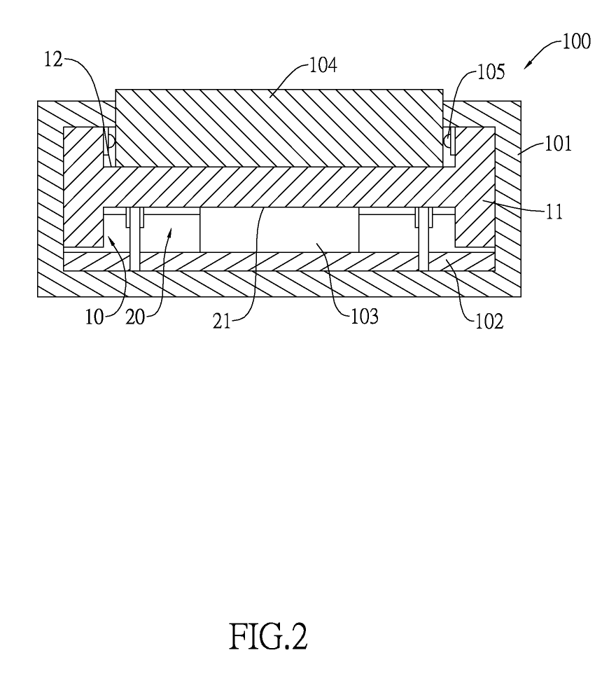

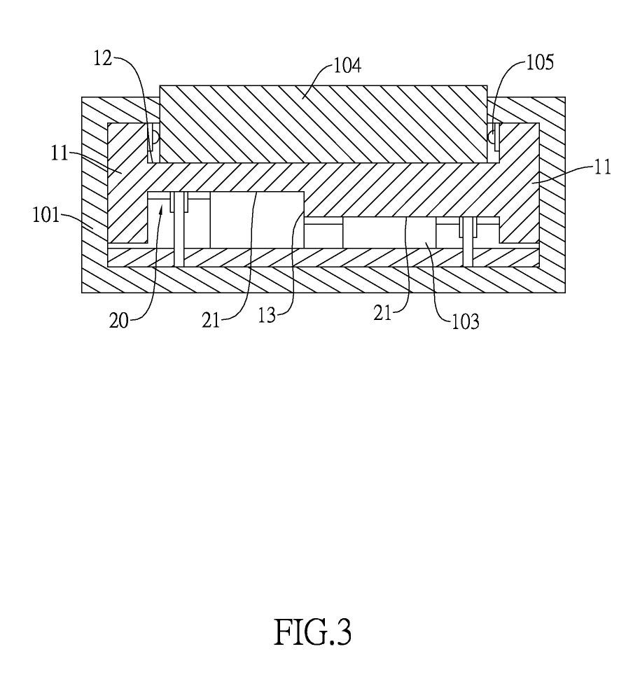

With reference to FIG. 2, the heat sink in accordance with the present invention is mounted in an electronic device 100. The electronic device 100 comprises a housing 101, a circuit board 102, at least one electronic component 103 and at least one input unit 104. The heat sink is mounted inside the housing 101 and makes the sidewalls 11 of the stand 10 abut inner surfaces of the housing 101. The circuit board 102 is mounted inside the housing 101. The at least one electronic component 103 is mounted on the circuit board 102 and is received in one chamber 12 of the stand 10 to allow a top of the electronic component 103 to contact the lower surface of the stand 10 through the hole 21 of the nano-carbon film 20. The at least one input unit 104 is received in the other chamber 12 of the stand 10. Preferably, each sidewall 11 has a light source 105 mounted thereon. The light source 105 may be a light emitting diode (LED) or any other suitable light source. Further, with reference to FIG. 3, the lower surface of the stand 10 may be designed according to the heights of different electronic components 103 so as to form a step surface 13.

Therefore, the heat generated by the electronic component 103 can be dissipated efficiently by both the stand 10 and the nano-carbon film 20. Besides, the heat sink is small in size so that it can be applied to small electronic devices. Moreover, the stand 10 can hold the input unit 104 and structurally reinforce the plastic housing 101 and thus manufacturing cost can be reduced because no metal panel is required.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A heat sink comprising:
a stand made of strong and thermally conductive material and including
a lower surface;
two sides; and
two sidewalls respectively formed on the sides of the stand; and
a nano-carbon film formed on the lower surface of the stand and including at least one hole.

2. The heat sink as claimed in claim 1, wherein the sidewalls of the stand extend upward and downward so as to form two chambers between the sidewalls.

3. The heat sink as claimed in claim 1, wherein the sidewalls of the stand extend upward so as to form a chamber between the sidewalls.

4. The heat sink as claimed in claim 1, wherein the nano-carbon film is made of carbon nanotubes.

5. The heat sink as claimed in claim 2, wherein the nano-carbon film is made of carbon nanotubes.

6. The heat sink as claimed in claim 3, wherein the nano-carbon film is made of carbon nanotubes.

7. The heat sink as claimed in claim 1, wherein the nano-carbon film is made of graphene.

8. The heat sink as claimed in claim 2, wherein the nano-carbon film is made of graphene.

9. The heat sink as claimed in claim 3, wherein the nano-carbon film is made of graphene.
